(19) United States
(12) Patent Application Publication
(10) Pub. No.: US 2017/0200183 A1
(43) Pub. Date: Jul. 13, 2017

(54) SYSTEMS AND METHODS FOR PROVIDING A SOCIAL MEDIA PLATFORM WITH A LOYALTY SYSTEM

(71) Applicant: MANJA TECHNOLOGIES SDN BHD, Johor Bahru (MY)

(72) Inventor: Chern Chuen Lim, Johor Bahru (MY)

(73) Assignee: Manja Technologies SDN BHD, Johor Bahru (MY)

(21) Appl. No.: 15/325,010

(22) PCT Filed: Jul. 9, 2014
(86) PCT No.: PCT/MY2014/000208

§ 371 Date: Jan. 9, 2017

(51) Int. Cl. G06Q 30/02; G06Q 50/00

(52) U.S. Cl. CPC G06Q 30/0226; G06Q 30/0224; G06Q 50/01

(57) ABSTRACT

Systems and methods for providing a loyalty system with a social media platform are disclosed. The loyalty system maintains records of the total amount of purchase from vendors in a set of vendors and for each of one or more specific vendors or group of affiliated vendors. The user may then obtain rewards based upon each type of tracked purchases. Furthermore, the social media platform provides other ways of obtaining rewards such as meeting certain challenges in a game play manner. Furthermore, the system uses user account information to determine information to provide to the user in order to direct relevant product and vendor information to the user.

### FIELD OF THE INVENTION

This invention relates to a social media platform and more particularly to a social media platform that provides a loyalty system.

### BACKGROUND OF THE INVENTION

Most people in today's society interact with one or more social media networks. As social media platforms have evolved, more information has become available on the social media networks. As more information has become available on these networks, people have begun to use the networks to research goods and services to use and/or purchase. As this has occurred, vendors including merchants and service providers have sought ways to become more accessible on the social media networks to advertise their offered goods and services.

In order to promote goods and/or services provided by a vendor, some platform developers have provided games that allow a vendor to promote their products either as a feature of game play or as a reward for meeting a certain metric in a game. Furthermore, the platform may allow user to share their experiences and to recommend a game and/or advertised products to others. One such system is disclosed in US Patent Publication 2012/0214568 A1 in the name of Hermann and entitled “Apparatus and Method for Supporting Applications in a Distributed Networks”, published 23 Aug. 2012.

Furthermore, many social media platforms allow users to provide commentary on goods and services. These systems may also provide recommendations to a particular user about advertised products the user may be interested in based upon the previous interactions of the user with networks including commentaries provided, information reviewed and/or games played. Such a system is disclosed in US Patent Publication 2012/0323688 A1 in the name of Mesaros and entitled “Promoting Offers Through Social Network Influencers”, published 20 Dec. 2012.

Another common method for promoting goods and/or services provided by a vendor is a loyalty card system. In a loyalty card system, a user is assigned a unique identifier. The user may then present the identifier to a particular vendor or group of vendors during a purchase and the identifier is used to maintain a record of the purchases of the user from the particular vendor or group of vendors. The user is then provided rewards and/or special offers based on the tracked purchases. An example of such a system is disclosed in US Patent Publication 2011/0270666 in the name of Welsh et al. and entitled “System and Method for Providing Financial Incentives and Disincentives Based Upon Consumer Activities”, published 3 Nov. 2011.

Heretofore, the concept of a loyalty system incorporated into a social media platform has not been implemented. One particular problem with providing a loyalty system in a social media network is how such a system can be provided in an environment that may include vendors that are direct competitors with one another. In the past, a loyalty card system was implemented to encourage a user to shop and/or use a particular vendor or group of vendors. Thus, the user was rewarded by using the particular vendor and discouraged from using competing vendors. However, this model does not work well in a social media context. In particular, most vendors are seeking brand loyalty meaning that the vendors prefer that a consumer only use the particular vendor to the exclusion of others while users would prefer to be rewarded for all purchases from the participating vendors regardless of whether particular vendors are in direct competition with one another. As such, there is a need for a system that meets both objectives in a social media context.

Furthermore, a social media platform needs to provide information that is useful to a user based upon user preferences. The user preferences may be input or determined by the usage of the social media platform of the user. In order to easily search for postings containing information that may be of interest to a user, some systems, such as, but not limited to the system disclosed in U.S. Pat. No. 8,209,337 entitled “Content Recommendation Apparatus and Method Using a Tag Cloud” issued on 26 Jun. 2012 to Jong-Hun Park, describe the use of tags to categorize information in content. However, such systems do not provide an adequate system for using the tags to provide content to a user based upon user preferences.

### SUMMARY OF THE INVENTION

The above and other problems are solved and an advance in the art is made by the provision of systems and methods for providing a social media platform with a loyalty system in accordance with embodiments of this invention. A first advantage of embodiment of the invention is that a system provides a loyalty system in which all purchases including purchases between competing vendors are used to determine rewards to a user. A second advantage of systems and methods in accordance with embodiments of this invention is that the system facilitates competing vendors to participate in the loyalty system because a system is provided that measures repeated use of a particular vendor and/or group of vendors. A third advantage is that each vendor is assured that the expense of the reward system is accounted for by the purchases made with the particular vendor and/or within an affiliated group of vendors. A fourth advantage is that the social media network promotes dissemination of information by users through providing processes for eliciting information from the users and processes for disseminating the information to other users within the network.

In accordance with some embodiments of this invention, a loyalty club is provided in the following manner. The social network platform maintains a cumulative purchase record of a total amount of purchases by a user from a set of participating vendors. The cumulative purchase record stores a cumulative metric indicates a total amount of currency spent on purchases by the user from the set of participating vendors. The platform also maintains a specific vendor purchase record of total purchases by the user from a specific vendor and/or group of vendor. The specific vendor purchase record stores a specific vendor metric that indicates a total amount of currency spent on purchases from the specific vendor and/or group of vendors.

When a user makes a purchase at a participating vendor, the platform receives an indication of a purchase by the user from the specific vendor. The indication includes an amount of the purchase, an identifier of the user and an identifier of the vendor. The platform updates the cumulative purchase record of total purchases of the user based upon the amount of the purchase. The platform also determines whether a specific vendor record exists for the particular vendor and/or a group of vendors that includes the vendor of the purchase. If a specific vendor record exists, the specific vendor record is updated by changing the specific vendor metric based upon the amount of the purchase.

In accordance with some embodiments of the invention, the cumulative purchase record is updated in the following manner. The platform retrieves a set of rules for cumulative purchases applicable to the user and the set of rules are applied to the purchase to determine the change to the cumulative metric.

In accordance with some embodiments of the invention, the specific vendor record is updated in the following manner. The platform retrieves a set of rules for specific vendor purchases applicable to the user and applies the set of rules for specific vendor purchases to the purchase to determine the change to the specific vendor metric.

In accordance with some embodiments of the invention, the platform determines whether a mobile device is associated with the user from stored user account information in response to receiving the indication of a purchase. If the user has an associated mobile device, the platform provides a feedback template to the mobile device associated with the user and receives a populated template from the mobile device that includes feedback data input by the user. The platform stores the feedback data and links the feedback data to the user, a product, a service, a vendor, and/or a vendor location. In accordance with a number of these embodiments of the invention, the platform provides a comment code that corresponds to the purchase to a point of sale device for printing of the code on a receipt. The platform may then later receive the comment code from a user device and provide feedback template to the user account in response to receiving the comment code. The platform then receives a populated template from the user of the user device that includes feedback data input by the user. The platform stores the feedback data and links the feedback data to the user, a product, a service, a vendor, and/or a vendor location based on the comment code.

In accordance with some embodiments of the invention, the platform receives an indication that a user device associated with the user is detected at a vendor location. Based on the location, the platform determines whether the user is eligible for a reward for being at the vendor location. If it is determined that the user is eligible for a reward, the platform updates the user account with an indication of the reward.

In accordance with some embodiments of the invention, the platform receives an indication that a user device associated with the user is detected at a vendor location. The platform then determines a number of devices associated with users affiliated with the user that are also detected in the vendor location and determines whether the determined number of devices in the vendor location is greater than a threshold. Based on the comparison of the number of devices to the threshold, the platform determines whether the user and users affiliated with the user at the vendor location are entitled to a reward and updates the user account of the user and user account of each user affiliated with the user in the vendor location with an indication of the reward.

In accordance with some embodiments, the platform receives a request from a user to redeem a metric from either the cumulative purchase record or the specific vendor record for a reward. In response to the request, the platform determines rewards that may be obtained using the selected metric and provides a list including the determined rewards to the user. The platform receives a selection of a particular reward from the user and provides a voucher for the reward to the user account of the user. In accordance with some of these embodiments, the platform also updates the metric in the selected record to indicate the redemption of the reward.

In accordance with some embodiments, the platform receives a request to use a reward by the user from a vendor system. The platform verifies the reward in the user account of the user. The platform then updates the user account to indicate the reward is redeemed and transmits an indication of the reward to the vendor system.

In accordance with a number of embodiments of this invention, the platform receives a request from a user to provide information about a particular item to the user account of the user. In response to the request, the platform retrieves information related to the item from the memory. The platform then determines a source user for each piece of information related to the item and compares stored user information about the user to stored user information about the source user for each piece of information to generate a comparison metric for the source user. The pieces of information about an item are then ranked by the platform based on the comparison metrics for each of the source users and generate a display of the information based upon the ranked information about the item.

In accordance with some embodiments of the invention, the platform may compare users to determine information to provide to the users. In accordance with some of these embodiments, the comparison is performed in the following manner. The platform selects a group of other users to relate to the user. The platform then retrieves user information for the user and each user in the group of other users. The user information of the user is then compared to the user information for each user in the group of other users to generate a comparison metric. The platform then determines whether the comparison metric for each user in the group of other users is greater than a threshold and adds a link between the user and each user in the group of other users that is determined to have a comparison metric that is greater than the threshold. In accordance with some of these embodiments, the platform provides information to the user that is added to by each other user that is linked to the user based on the comparison metric.

In accordance with some embodiments of this invention, the user may also obtain rewards by interacting with the social media platform. A process of adding rewards to a user account based on interactions is performed in the following manner in some of these embodiments. The platform detects an interaction from the user and determines whether the interaction meets a reward metric for a reward available to the user. If the interaction meets a reward metric, the platform adds the reward to available rewards for redemption in the user account of the user. In accordance with some of these embodiments, the platform updates the reward metrics based upon the interaction in response to a determination that the interaction does not meet the reward metric.

In accordance with some embodiments of the invention, a social media platform provides information to a user based upon users preferences. A process for providing such information is performed in the following manner in accordance with some embodiments. The social media platform receives a trigger to search for information about a particular item in postings maintained by the social media platform from a user. In response to the trigger, the social media platform retrieves user preferences for the user from user information maintained by the social media platform and retrieves postings to the social media platform related to the particular item from memory. The social media platform compares the user preferences of the user to information in each of the retrieved postings to generate a comparison metric for each posting. Each posting about the particular item is ranked based on the comparison metrics for each posting and a ranked list of the postings is provided for use in satisfying an event that invoked the trigger.

In accordance with some embodiments, the retrieving of information is performed by searching each posting for tags associated with the particular item requested by the user and retrieving each posting that includes the tags associated with the particular item.

In accordance with some embodiments, the social media platform maintains a set of tags that are used to categorize information in postings to a social media platform. In accordance with a number of embodiments, the set of tags categorize the information by providing a type of item category, an item identifier, and one or more descriptors of the item based on the type of item category.

In accordance with some embodiments, tags may be inserted into a posting in the following manner. The social media platform receives a posting to the social media platform. The platform then analyzes the data in the posting and determines one or more tags from the set of tags maintained to add to the posting to categorize the information in the posting. The one or more tags are then added to the posting and the posting is stored for use in the social media platform. In accordance with some of these embodiments, the social media platform provides a display of the one more tags determined for the posting to a user and receives an acceptance of the one or more tags from the user prior to adding the one or more tags to the posting.

In accordance with some embodiments, the social media platform provides a process for posting information to the social media platform that is performed in the following manner. The social media platform receives a request to enter a review from a user. In response to the request, the social media platform provides a template to the user. The platform then receives text entered into the template by the user and determines one or more tags from the set of tags that categorize the information in the text. The one or more tags are then provided in a display to the user. The platform then receives an acceptance of the one or more tags from the user and inserts the one or more tags into the template including the review. The posting is then stored for use by the social media platform.

### BRIEF DESCRIPTION OF THE DRAWINGS

The above and other features and objects of embodiments in accordance with this invention are shown in the following drawings:

FIG. 1 illustrating a system including devices for providing and interacting with a social media platform in accordance with embodiments of this invention;

FIG. 2 illustrating a block diagram of components of a processing system as an example of a processing system in each of the devices providing and interacting with a social media platform in accordance with embodiments of this invention;

FIG. 3 illustrating a flow diagram of a process for updating a user account in response to a purchase being made at a specific participating vendor in accordance with embodiments of this invention;

FIG. 4 illustrating a flow diagram of a process for interacting with a mobile device of a user with a social media platform in accordance with embodiments of this invention;

FIG. 5 illustrating a flow diagram of a process for eliciting comments from a user about an experience at a specific vendor in response to a transaction in accordance with embodiments of this invention;

FIG. 6 illustrating a flow diagram of a process for receiving information in the social media platform when an image is uploaded to the platform in accordance with embodiments of this invention;

FIG. 7 illustrating a flow diagram of a process for redeeming points and/or rewards in accordance with embodiments of this invention;

FIG. 8 illustrating a flow diagram for redeeming a voucher at a point of sale in accordance with embodiments of this invention;

FIG. 9 illustrating a flow diagram for providing information about a particular item in accordance with embodiments of this invention;

FIG. 10 illustrating a flow diagram for providing awards based upon an interaction in accordance with embodiments of this invention;

FIG. 11 illustrating of a posting including tags to categorize the information in the posting in accordance with embodiments of this invention;

FIG. 12 illustrating a flow diagram of a process for generating a posting that includes tags categorizing the information in the posting in accordance with embodiments of the invention;

FIG. 13 illustrating a flow diagram of a process for adding tags that categorize the information in the post in accordance with embodiments of the invention;

FIG. 14 illustrating a flow diagram of a process for searching postings for information that may be of interest to a user based upon user preferences in accordance with embodiments of the invention; and

FIG. 15 illustrating a flow diagram of a process performed by the social media platform to allow a user to redeem a voucher and/or pay the remainder of a cost for the transaction in accordance with an embodiment of this invention.

### DETAILED DISCLOSURE OF THE INVENTION

Turning now to the drawings, systems and methods for providing a social media platform with a loyalty system are disclosed. In accordance with embodiments of the invention, the social media platform provides a social media network in which users and vendors may interact. A loyalty system is incorporated into the social media platform. In the loyalty system, each user has a loyalty circle. The loyalty circle includes a set of participating vendors that a user can frequent to earn rewards. In accordance with some embodiments, the loyalty circle includes all participating vendors. In accordance with other embodiments, the loyalty circle may only include a set of vendors selected by the user. In accordance with a number of embodiments, the user may implicitly include a particular vendor in the loyalty circle by meeting certain criteria for achieving loyalty to the particular vendor causing the particular vendor to be added to the loyalty circle. In accordance with further of these embodiments, the set of vendors may only include non-competing merchants.

In accordance with embodiments of this invention, the loyalty system tracks the total amount of purchases of the user from the vendors in the loyalty circle of the user and the total amount of purchases from each specific vendor and/or specific group(s) of affiliated vendors. A group of affiliated vendors are non-competing vendors that have agreements that allow a user to use purchases in any of the stores towards a reward at one or more of the affiliated merchants. The total amount of purchases is measured by a metric in each case. In the case of the total amount of purchases from all of the merchants in the loyalty circle, a cumulative purchase metric is maintained and in the case of a specific vendor and/or group of vendors, a specific vendor metric is maintained. Each metric is an indication of the total amount of the purchases and may be in the form of points and/or monetary value in accordance with some embodiments. An adjustment of the metric is performed to reflect a purchase based on a set of rules that are associated with the user. These rules may be adjustable such that the amount of a metric earned for a purchase changes if the user makes purchases at competing vendors in accordance with embodiments of the invention. This kind of change encourages a user to only frequent and/or add non-competing vendors to the loyalty circle in order to achieve the greatest change in metrics for the purchases.

The loyalty circle allows a vendor in a loyalty circle of a user to enable the user to enjoy even greater change of metrics or better exclusive rewards for repeated patronage of the vendor. The rewards available to users for repeated purchases may also be increasing in value as a user makes further purchases from a particular vendor. The increasing value of awards naturally incentivizes a user to continue patronizing at a particular vendor, as user incurs an opportunity cost when user does not patronize the same vendor. The concept of loyalty circle serves to further strengthen this effect. The concept also enables multiple competing vendors to coexist on the same loyalty system and provides freedom to a user in choosing which vendor to patronize.

The cumulative metric may be used by the user to obtain a specific set of rewards. In accordance with some embodiments, this specific set of rewards includes rewards redeemable at any of the vendors in the loyalty circle of the vendor. In accordance with other embodiments, the rewards are gifts, discounts, or other rewards that are obtained from a specific vendor. In these embodiments, each vendor provides a specific set of rewards for which the cumulative metric may be redeemed. In accordance with a number of embodiments, the cumulative metric may be redeemed at any vendor in the loyalty system including those vendors that may not be in a loyalty circle of a particular user. In accordance with some embodiments, these rewards have a very low value compared to the amount spent because the realization of purchases by a particular vendor to the value of the gifts provided is much lower for each vendor in the loyalty circle as the metric includes purchases made at other vendors that are of no value to the particular vendor.

Likewise, the specific vendor metric may be redeemed for rewards from the specific vendor and/or affiliated vendors. As this metric is measuring vendor loyalty, the rewards provided for redemption of the metric have a higher value of sales compared to the cost of the reward. As with the cumulative metric, the rewards for the specific vendor metric may include, but are not limited to, gifts, spending vouchers, discounts, or other types of rewards. As such, the rewards available for the specific vendor metric often have a higher value and/or may be obtained by redeeming less of the specific vendor metric than rewards available using the cumulative metric. In a number of embodiments, the user may also redeem a combination of the cumulative metric and specific vendor metric to redeem for a particular award when the user does not have sufficient specific vendor metric to obtain the reward. In accordance with some embodiments, the cumulative metric and/or specific vendor metric may be redeemed using a POS device, and/or application provided by a mobile device to pay for goods and/or services at a vendor site.

Furthermore, the social media platform may include other manners in which to earn rewards. These may be in a game type manner in which challenges are presented to the user and the user obtains a reward by meeting a challenge metric. In accordance with some of these embodiments, the challenges may include specific interactions such as, but not limited to, commenting on certain number of products from a specific vendor, recommending the specific vendor to a certain number of other users, or obtaining a certain score on an entertainment game. These interactions are valuable to a vendor as the interactions expose the merchant to more potential consumers and keep existing patrons engaged with the vendor by encouraging the user to visit the vendor to redeem the reward. In some particular embodiments, the social media platform may provide rewards to users for organizing a meeting of a group of users at a particular vendor. In accordance with these embodiments, the user and/or members of the group may be provided an award for organizing the meeting using the social media platform and/or upon detection of the group at the location of the vendor. In a number of embodiments, entertainment games may be provided and the challenge metric is based upon the play of the game. Examples of games that may be provided include, but are not limited to, a “name the price” game, and “guess the product” game. Such games may provide additional viewership to the particular item/business in order to increase advertising ‘eyeballs’ to the item.

In accordance with some embodiments of the invention, the social media platform also provides an improved means for targeting marketing material of vendors to users more likely to use/buy the vendors goods and/or services. The improved targeting of material includes features for obtaining feedback from current users and distribution of the material to users likely to be interested in a particular vendor. In accordance with embodiments of this invention, the obtaining of feedback includes prompting a user for feedback at the time of a purchase. This may be performed by providing a prompt to a mobile device of the user at the time of purchase to obtain feedback. In addition, rewards may be provided for providing the feedback in accordance with a number of embodiments. To assure that the feedback is easily understandable and searchable, the feedback may be obtained in a structured manner such as, but not limited to, population of a provided template in some embodiments. The template may include pre-defined categories and/or metrics to help the user express opinions about the goods and/or services of the vendor.

Furthermore, the social media platform may use user information stored by the system to determine information to provide to a user in accordance with some embodiments. In some of these embodiments, the platform compares user information from the user obtaining the information with the user information from the user providing the information. The user is then only provided information from users that have a similarity metric with the user that is above some predetermined threshold. In some of these embodiments, the information provided to the user may be ranked based on the similarity metrics between the information providers and the user; and displayed to the user based upon the rank. Furthermore, the ranked information may be used to generate a display that uses visual cues as to the similarity between the user and the provider in order to denote the relevance of the information in some of these embodiments.

In some embodiments, a similarity metric may also be used to link users. User information for one user is compared to the user information of a second user to determine a similarity metric. The user accounts of users having a similarity metric above a certain threshold are then linked. When one user subsequently supplies information such as, but not limited to, a comment, feedback, or recommendation of a product, the information is provided to the user account of each linked user. This provides a user information that may relevant to the user as the user is likely to have similar tastes and/or interests to the user providing the information.

In accordance with some embodiments of the invention, the social media platform provides a manner of identifying and/or classifying subject matter added to the social media platform to allow easier searching and/or understanding of the material. In accordance with many embodiments, the social media platform provides a tagging system that includes a specific nomenclature for the tags to allow for easy identification of the content. In accordance with a number of embodiments, the tags are added to the content as commonly used markers such as, but not limited to, hash-tags ‘#’ and the ‘@’ symbols. In accordance with several embodiments, the tags may be added to metadata of the content. In accordance with some embodiments, a specific data structure including fields for the tags may be used.

In accordance with some embodiments, the tags include a category identifier, an item identifier, and one or more descriptors. One skilled in the art will recognize that each category identifier, item identifier and/or descriptor be associated with one or more tags to distinguish each particular identifier and/or descriptor. The different types of tags allow a user to quickly and easily identify the information being conveyed. In accordance with many embodiments, the social media platform provides a template for entering reviews that allows a user to select from maintained to tags to include in the review. In accordance with a number of embodiments, the platform provides a process for adding tags to information in postings added to the system.

Processes that provide the above features in accordance with embodiments of the invention are set forth below with respect to the drawings.

### Network Overview

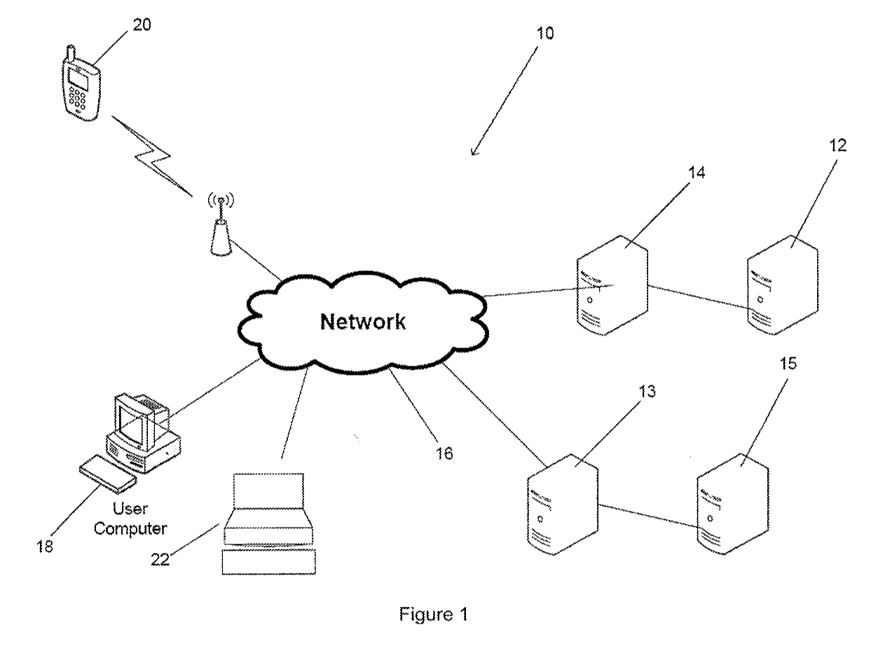

A system that includes processing devices that provide and/or interact with a social media platform having a loyalty system in accordance with embodiments of this invention is shown FIG. 1. System 10 includes network 16. Network 16 is a network such as the Internet that allows devices connected to network 16 to communicate with other connected devices. A platform server system is connected to network 16 and provides a social media platform. The platform server system includes servers 12 and 14 that are communicatively connected to one another by an internal network. Servers 12 and 14 perform the processes for providing a social media platform and store data associated with the social media platform. Those skilled in the art will recognize that while two servers are shown, any number of servers may be included in platform provider system. Furthermore, one or more database servers (not shown) may be communicatively connected to servers 12 and 14 to store data for providing the social media platform.

Users interact with the social media platform using personal devices 18 and 20 that connect to the platform server system over network 16. In the shown embodiment, personal device 18 is shown as a desktop computer that is connected via a conventional “wired” connection to network 16. However, personal device 18 may be a desktop computer, a laptop computer, a smart television, an entertainment gaming console, or any other device that connects to network 16 via a “wired” connection. Mobile device 20 connects to network 16 using a wireless connection. A wireless connection is a connection that uses Radio Frequency (RF) signals, Infrared signals, or any other form of wireless signaling to connect to network 16. In FIG. 1, mobile device 20 is a mobile telephone. However, mobile device 20 may be a mobile phone, Personal Digital Assistant (PDA), a tablet, a smartphone, or any other type of device that connects to network 16 via wireless connection without departing from this invention.

Point of Sale (POS) device 22 is a device connected to network 16 via a wired or wireless connection in a vendor location for use in conducting transactions between users and vendors. In accordance with some embodiments, the POS device 22 may be a device with actual POS functionality. In accordance with some other embodiments, the POS device 22 is integrated with a third-party POS application in a separate device. In accordance with a number of embodiments, the POS device may be a device that is separate from the POS system of the vendor. Although shown as directly connected to network 16, POS device 22 may be connected to network 16 via an internal vendor network that includes servers and the like. Furthermore, POS device 22 may connect to a vendor server system that includes servers 13 and 15 that in turns access the social network platform servers.

### Example of a Processing System

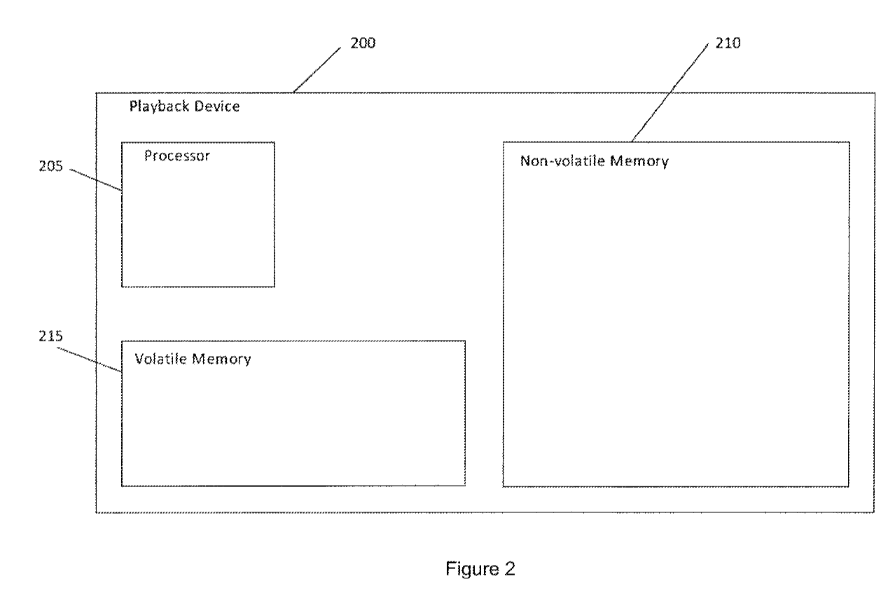

An example of a processing system that executes instructions to perform processes that provide applications, such as the processes that provide and interact with the social media platform in the various devices shown in FIG. 1 in accordance with embodiments of this invention is shown in FIG. 2. One skilled in the art will recognize that a particular processing system may include other components that are omitted for brevity without departing from this invention. The processing device 200 includes a processor 205, a non-volatile memory 210, and a volatile memory 215. The processor 205 is a processor, microprocessor, controller, or a combination of processors, microprocessor, and/or controllers that performs instructions stored in the volatile 215 or non-volatile memory 210 to manipulate data stored in the memory. The non-volatile memory 210 can store the processor instructions utilized to configure the processing system 200 to perform processes including processes in accordance with embodiments of the invention and/or data for the processes being utilized. In other embodiments, the processing system software and/or firmware can be stored in any of a variety of non-transient computer readable media appropriate to a specific application. A network interface is a device that allows processing system 200 to transmit and receive data over network based upon the instructions performed by processor 205. Although a processing system 200 is illustrated in FIG. 2, any of a variety of processing system in the various devices can configured to provide the methods and systems in accordance with embodiments of the invention can be utilized.

### Processes for Providing a Social Media Platform With a Loyality System

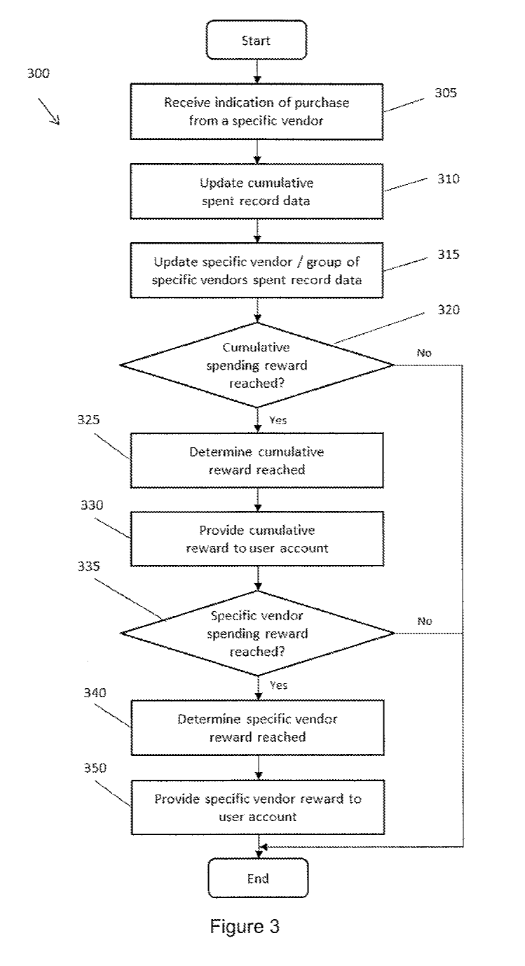

FIGS. 3-10 illustrate for diagrams of processes that are performed to provide a social media platform in accordance with embodiments of the invention as described above. One skilled in the art will recognize that the data stored, data structures and exact implementation of the processes performed will vary depending on the configuration of the particular social media platform and/or processing systems used to provide the platform. In order to provide a loyalty system, the user is assigned a loyalty club identifier which is a code that is used to associate a particular user with a particular purchase. The code may be provided using a card that has a magnetic memory chip, an RFID chip, a NFC code stored on an NFC device, a unique QR code stored on a mobile device, or in any other similar manner. The user provides the identifier to a vendor when making a purchase. The identifier than associates the purchase with user account that includes information such as the cumulative purchase record and specific vendor purchase record(s) maintained for the user by the platform.

A process performed by a social media server system to monitor purchases in a loyalty system in accordance with embodiments of the invention is shown in FIG. 3. Process 300 begins when an indication of a purchase is received from a vendor system (305). As discussed above, the identifier of the user and the purchase details are captured by a POS device in the vendor location and provided to the social media platform either directly from the POS or from a vendor server system. In some embodiments, the indication of a purchase is sent at the time the purchase is made. In accordance with other embodiments, records of the purchases made from the vendor may be stored and sent as a batch to the social media platform. In order to process the purchase, the indication of the purchase includes at least the amount of the purchase, the identifier for the user and the identifier for the vendor in accordance with some embodiments of this invention.

A cumulative purchase record of the user is updated based upon the indicated purchase (310). The purchase record is updated by changing the cumulative purchase metric in the cumulative purchase record. The cumulative purchase metric is an indication of the total amount or value of the purchases made by the user at the set of vendors of the user's loyalty circle. The cumulative purchase metric may be points, a value tracker indicating the monetary value of the purchases, or any other metric that the system may use that is maintained to determine the rewards available to the user based upon the total purchases of the user. Furthermore, as stated above, the set of vendors in the loyalty circle may include all participating vendors, or a group of vendors selected by the user.

The cumulative purchase metric is updated according to rules applicable to the user for a purchase from the particular vendor. The rules may be customizable to the particular user in accordance with embodiments of the invention. In order to discourage a user from including competing vendors in the loyalty circle, the rules may change to make the value of each purchase less when a user includes competing vendors in their loyalty circle and/or when the user makes a purchaser from a competing vendor in accordance with some embodiments. Furthermore, the rules may change to increase or decrease the values of the metric based upon the time and/or circumstances of the purchase in accordance with some embodiments of this invention in accordance with many embodiments. For example, the less of the metric may be given for purchases made during a sales event and/or for particular types of items. The rules for the user are retrieved and applied to the purchase to determine the adjustment to the metric and the cumulative purchase record of the user is updated accordingly.

The platform then determines whether the user has a specific vendor purchase record that tracks purchases from a subset of the vendors in the loyalty circle of the user that includes the vendor where the purchase is made. The subset may be an individual vendor or a group of one or more affiliated vendors that include the particular vendor. If a specific vendor purchase record exists that tracks purchases from the identified vendor, the platform updates the specific vendor purchase record of the user (315). The specific vendor purchase record is updated by changing a specific vendor metric in the specific vendor purchase record. The specific vendor metric is an indication of the total amount or value of the purchases made by the user at the subset of vendors including the identified vendor. The specific vendor metric may be points, a value tracker indicating the monetary value of the purchases, or any other metric that the system may use that is maintained to determine the rewards available to the user based upon the total purchases of the user at the subset of vendors.

The specific vendor metric is updated according to rules applicable to the user for a purchase from the particular vendor. The rules may be customizable to the particular user in accordance with embodiments of the invention. In accordance with some embodiments, the rules may change to increase or decrease the values of the metric based upon the time and/or circumstances of the purchase in accordance with some embodiments of this invention. For example, less of the metric may be obtained for purchases made during a sale event and/or for particular types of items. The rules for the user are retrieved and applied to the purchase to determine the adjustment to the specific vendor metric and the specific vendor purchase record of the user is updated accordingly.

Furthermore, the process may determine whether a cumulative purchase reward is immediately available to the user has been reached with the purchase (320). The platform retrieves a list of the rewards for cumulative purchases and determines whether the user has a sufficient amount of the cumulative purchase metric to redeem for one or more rewards and/or any awards that are provided automatically based on the metric (325). If the platform determines that the list includes rewards available to the user, the platform provides the determined rewards to the user account of the user (330).

Likewise, the platform may also determine whether a specific vendor reward is immediately available to the user has been reached with the purchase (335). The platform retrieves a list of the rewards for specific vendor purchases and determines whether the user has a sufficient amount of the specific vendor metric to redeem for one or more rewards and/or any awards that are provided automatically based on the specific vendor metric (340). If the platform determines that the list includes rewards available to the user, the platform provides the determined rewards to the user account of the user (350). Process 300 then ends.

Although a specific process for tracking a purchase performed by a social media platform is described above with respect to FIG. 3, any of a variety of processes may be utilized in accordance with embodiments of the invention.

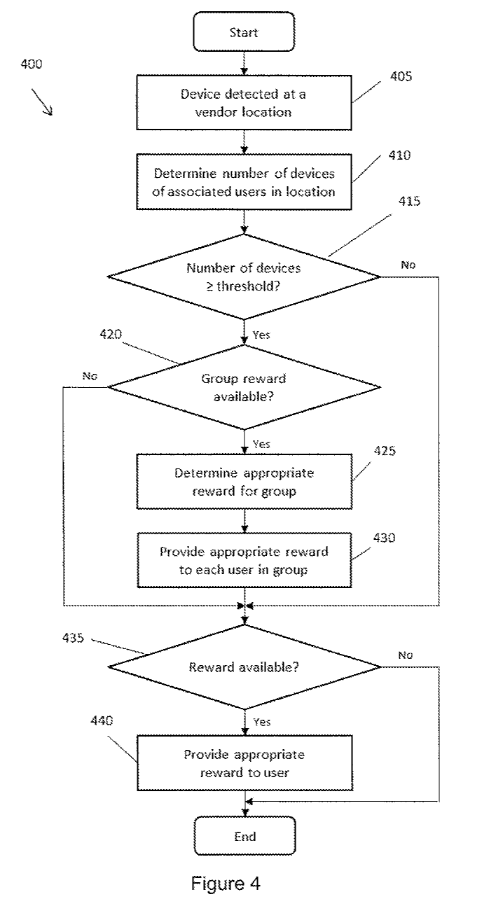

In accordance with some embodiments of this invention, a reward may be given to a user for performing other interactions besides making purchases with vendors. In accordance with some of these embodiments, a user may be rewarded for scheduling a visit and/or actually visiting a vendor with a group of associated users. A process performed by the platform for rewarding a user for visiting a vendor with a group of associated users in accordance with embodiments of the invention is shown in FIG. 4.

Process 400 begins by receiving an indication that a mobile device associated with a user is detected at a vendor location (405). The mobile device may be detected through Global Positioning System (GPS) data; detection of the device using RF signals including, but not limited, RFID signals, QR code scans and NFC signals; and or a message sent by the user to the system either through an interface on the device or through a common messaging system such as, but not limited, Short Messaging System (SMS) messages.

In response to the indication that the user device is detected at the vendor location, the platform determines the number of devices at the location that are associated with other users that are associated with the user (410). This may be performed by retrieving location information for the devices of each user that is associated with the user. For example, a platform may perform a search of each user that is a “friend” of the user and determine if a device associated with the “friend” is also at the vendor location.

The number of users may then be compared to a threshold value to determine whether a sufficient number of associated users are at the vendor location (415). One skilled in the art will note that is an optional step and in some cases just the presence of associated users is enough to provide a group reward. If the platforms determines a sufficient number of associated users are present, or as a result of a number of users being present, the platform determines whether the group is eligible for a reward from the vendor (420). If so, the appropriate reward is determined (425) and provided to each user in the group (430). Alternatively, or in addition to the group reward, an individual user may be eligible for a reward for visiting the vendor location. The platform determines whether an individual reward is available to the user (435) and provides any available reward to the user (440). After all rewards available are provided to the appropriate user accounts, process 400 ends.

Although a specific process for providing rewards for visiting a vendor location performed by a social media platform is described above with respect to FIG. 4, any of a variety of processes may be utilized in accordance with embodiments of the invention.

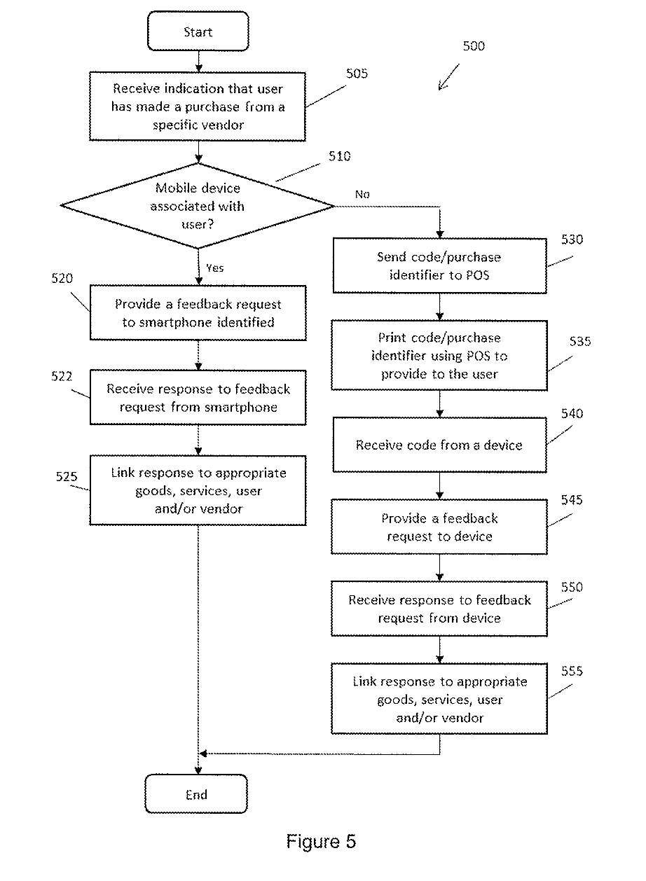

In accordance with some embodiments of the invention, the loyalty system is also used to elicit feedback from the user and stores information provided by user in a manner that is easily searchable and understandable by other users. In accordance with a number of these embodiments, the user is prompted for feedback when a purchase is detected. The user may then be given a reward or a chance for obtaining a reward by providing such feedback. A process performed by a social media platform to obtain feedback when a purchase is made at a participating vendor is shown in FIG. 5.

Process 500 begins by the platform receiving an indication that a user has made a purchase (505). This indication is the same indication that is used in a tracking process as described above with reference to FIG. 3. The platform determines whether there is a mobile device associated with the user (510).

If a mobile device is associated with the user, a feedback request is provided to the identified mobile device (520). In accordance with some embodiments, the feedback request is provided via an interface such as an “app” being executed by the mobile device. In accordance with some other embodiments, the request may be sent via SMS or some other messaging system. Furthermore, the request may include a template that the user may populate to input there comments. A template is desirable so that the feedback is received in an organized and simplified manner that allows portions of the feedback to be easily classified for storage in memory and/or searched by the social media platform.

A response to the request input by the user is then received from the mobile device (522). This may be by an upload from the “app” being executed by the mobile device or a reply message in a messaging system depending on the particular embodiment. The response is then stored and links from the stored response to the proper goods, services, vendor account, and/or user account are established by the media platform (525).

If the user does not have a mobile device associated with the user, the platform may transmit a purchase identifying code to the POS system (530). In accordance with some embodiments, the code may be embedded in a barcode or some other encoding. The POS system prints the code on the receipt for later use by the user (535). At a later time, the user accesses the social media platform and enters the code using a personal user device. In accordance with some embodiments, the request may be provided by scanning a barcode or other encoding of the code with the personal device. The social media platform receives the code from the personal device (540) and links the code to the purchase. The platform then provides a response request to the user device (545). The response request is similar to the request described above with respect to (520). The platform then receives the response to the request that may include the populated template depending on the embodiment of the invention (550) and establishes the appropriate links (555). Process 500 then ends.

Although a specific process for eliciting feedback from a user performed by a social media platform is described above with respect to FIG. 5, any of a variety of processes may be utilized in accordance with embodiments of the invention.

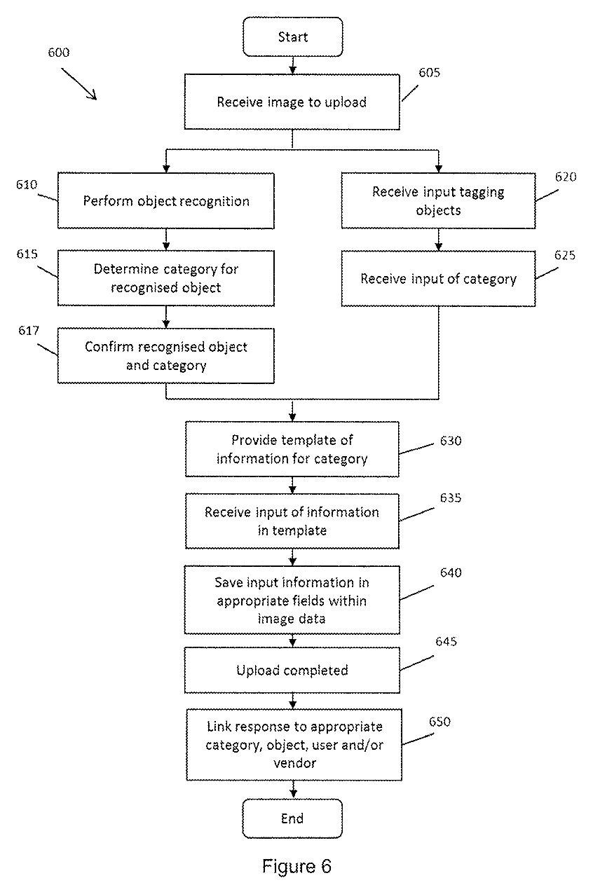

In accordance with some embodiments, the social media platform also provides processes that add information about products, services, or vendors in a manner that is easily searchable and in a form meaningful to users. In accordance with many of these embodiments, one manner of obtaining information is to obtain information about images uploaded to the social media platform by a user. A process for capturing information about objects in an image when the image is uploaded to a social media platform in accordance with embodiments of this invention is shown in FIG. 6.

Process 600 may begin in one of two optional ways. In the first way, the device uploading the image or a device performing the processes providing the social media platform perform receives or obtains an image (605). An object recognition search is performed on the image (610). This is to identify potential objects for commentary in the image and is performed in a conventional manner. For each recognized object, a category is selected and displayed to the user (615). The user then confirms the category or changes to another preferred category (617). In the second way, the image is received or obtained by the device that captured the image or a device providing the social platform (605). The process then allows the user to tag objects in a conventional manner (620) and to input the desired categories for each object (625).

The following is performed after the categories of the objects are received. A template for providing information about the category selected is provided to the user via an interface (630). The user inputs information into the template about the objects (635). The input information is saved within the image data (640) and the upload is completed (645). The templates make the input more searchable by placing the information about particular aspects of the object in known locations. This also makes the information more easily searchable and allows the information to be provided in a more user friendly manner in accordance with embodiments of this invention. After the image is uploaded, the platform links the image to the appropriate category, object, user, vendor and any other appropriate subject (650) and process 600 ends.

Although a specific process for eliciting feedback from a user during the uploading of an image performed by a social media platform is described above with respect to FIG. 6, any of a variety of processes may be utilized in accordance with embodiments of the invention.

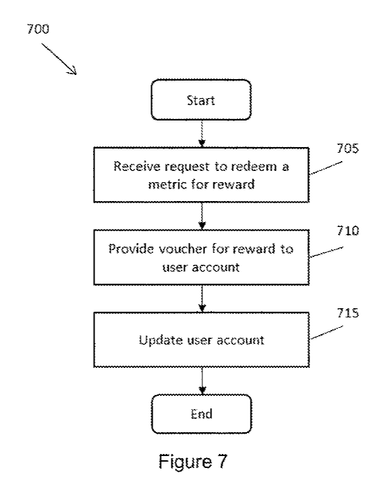

In accordance with embodiments of this invention, the user may redeem or use the cumulative purchase metric or the specific vendor metric to obtain a reward. A reward is something of value provided by a particular vendor or group of affiliated vendors. Examples of rewards include, but are not limited to, gift certificates, credit vouchers; gifts of goods or services products; discounts; services; or the like. A process for redeeming either the cumulative purchase metric or specific vendor metric for a reward in accordance with embodiments of the invention is shown in FIG. 7.

In process 700, the social media platform receives a request from a user to redeem and/or use either the cumulative purchase metric or a specific vendor metric to obtain a reward (705). The platform then retrieves a list of rewards that the user may obtain using the selected metric. In accordance with some embodiments, the rewards for the cumulative metric and each specific vendor metric are of different types. For example, the cumulative metric may be rewarded in a “cash back” manner while the vendor specific metric may be rewarded in terms of particular gifts and/or discount from a particular vendor and/or group of vendors. This may make the reward systems for both types of metrics easier to explain and/or understand. The list may be presented to the user in a visual display on an interface. In accordance with some embodiments, the display is simplified by showing the two types of metrics as different graphics. For example, the cumulative metric may be shown as points to spend and a specific vendor metric may be represented as a progress bar showing the amount of specific vendor metric that is needed to obtain the next reward. The user then selects one or more of the rewards to obtain.

In response to receiving the selection of one or more rewards to obtain, the social media platform updates the user account to indicate the reward (710). The update may be performed by providing a voucher to the user account that the user may later access and print for use at a vendor location. Alternatively or in conjunction to providing the voucher, the social media platform may place an indication in the user account that may be used by the vendor system to verify the reward when the reward is redeemed at a vendor location.

The social media platform then updates the selected metric to reflect the redemption of the reward (715). In accordance with some embodiments, this may include reducing the metric by an amount that reflects the use of the metric to obtain the reward. In accordance with some embodiments, this may include indicating in the proper purchase record that a particular reward has been redeemed. In accordance with a number of embodiments, the process 700 may also allow a user to share a reward with other users of the system and/or gift rewards to other users based upon the reward redeemed. Process 700 then ends.

Although a specific process for redeeming a metric for a reward performed by a social media platform is described above with respect to FIG. 7, any of a variety of processes may be utilized in accordance with embodiments of the invention.

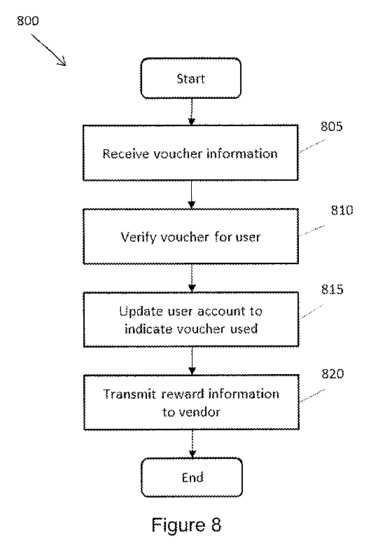

In accordance with some embodiments, a process to verify that a user has obtained reward is performed when a user attempts to redeem the reward with a particular vendor. A process for verifying a reward performed by a social media platform in accordance with embodiments of this invention is shown in FIG. 8. Process 800 begins when the social media platform receives voucher information from a vendor system (805). The voucher information may include an identifier of the voucher and an identifier of the user redeeming voucher in some embodiments.

Based upon the received voucher information, the social media platform verifies that the voucher for the reward has been provided to the user and that the user is entitled to the reward (810). The system also updates the user information to indicate that the voucher has been redeemed and is thus no longer valid (815). The social media platform then transmits a verification of the voucher to the vendor system to confirm the reward (820) and process 800 ends. In some embodiments, the confirmation may include details about the reward such as but not limited to an amount of a discount, an amount of a credit, or a cost of a particular item. The vending system may then adjust the transaction information for a purchase/redemption by the user accordingly.

Although a specific process for verifying a reward voucher performed by a social media platform is described above with respect to FIG. 8, any of a variety of processes may be utilized in accordance with embodiments of the invention.

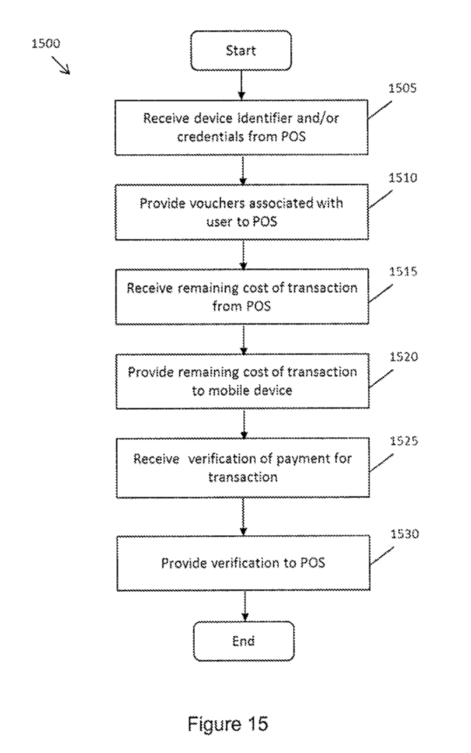

In some embodiments, the user may use an application or App on a mobile device to interact with a POS system and redeem a voucher associated with the user. A process performed by the social media platform to allow a user to redeem a voucher and/or pay the remainder of a cost for the transaction in accordance with an embodiment of this invention is shown in FIG. 15. Process 1500 is invoked in the following manner in accordance with the embodiment of the invention. The user proceeds to the proximity of a POS system in a vendor location. The user has a mobile device that provides an application or app for interacting with the social media platform. The POS receives an identification message from the mobile device that identifies the mobile device and/or user. In some embodiments, the message may include some form of user credentials that are used to identify the user. The POS then transmits the mobile device identity and/or credentials to the social media platform.

The social media platform receives the identity and/or credentials and authenticates the user associated with the mobile device (1505). In accordance with some embodiments, the POS system communicates with a mobile device of the user to obtain the identity and/or other credential information provided to the social media platform. In accordance with other embodiments, the POS device and mobile device each transmit at least a portion of the identity and credential information to the social medium platform. In still further embodiments, the POS and mobile device of a user perform a multi-step authentication process that includes providing a temporary password from the social media platform to the mobile user device which is then provided to the POS device in some manner. The social media platform then provides one or more vouchers to the POS that are available to the user for the particular vendor (1510). The POS then proceeds with the transaction. If the voucher does not cover the cost of the transaction, the POS transmits the remaining cost of the transaction to the social media platform. The social media platform receives the cost (1515) then provides the cost to the application being provided by the mobile device (1520). The user may use the application on the mobile device to make payment to the vendor via an internet payment gateway. When the transaction is completed, the application in the mobile device then provides a verification of payment to the social media platform in accordance with some embodiments. In some embodiments, the verification may be sent to the social media platform directly from the internet-payment gateway. The social media platform receives the verification of payment (1525) and provides the verification of payment to the POS (1530). In some embodiments, the verification information of the payment may be provided directly from the payment gateway to the POS. After the POS receives the verification of payment, the POS may then complete the transaction.

Although a specific process for providing an application that may interact with a POS to complete a transaction is described above with respect to FIG. 15, any of a variety of processes may be utilized in accordance with embodiments of the invention.

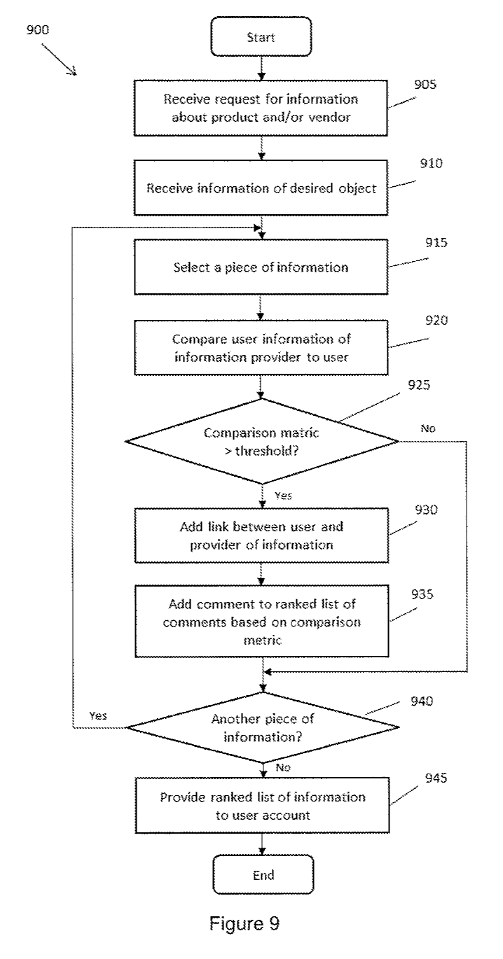

In many embodiments of this invention, the ability of the social media platform to provide information about a vendor; and/or the goods and/or services provided by the vendor is important. One manner in which a social media platform in accordance with embodiments of this invention improves the provision of information is by providing information to user in a manner that the user will find relevant. One manner of providing information in such a manner is to provide information from users that are similar to the user receiving the information. A process for providing requested information such that information is provided to the requesting user based upon the information about the user and the user providing the information in accordance with embodiments of this invention is shown in FIG. 9. Furthermore, the process in FIG. 9 shows a process that links users based upon the similarities between users so that information is provided that may be of interest to a particular user.

Process 900 begins by receiving a request for information about a subject from the user (905). The request may be for information about a particular subject such as a product, a service, a particular vendor, or any other type of information that may be of interest to the user. The social media platform then retrieves information related to the subject (910). The process then selects a piece of information (915) and determines the user that provided the information. The platform retrieves the user information for the information provider and the user requesting the information. The user information of the information provider user and the requesting user are then compared to determine a similarity metric (920). The comparison may be done using any number of comparison engines and the similarity metric is any metric that provides a measurement of the similarity between the users depending on the particular embodiment.

The similarity metric is then compared to a threshold (925). The threshold is dependent upon the metric and should indicate a reasonable amount of similarity between the users such that information relevant to one user is also relevant to the other user. If the similarity metric is greater than the threshold, the social media platform adds a link between the compared users (930). The link is some indication in the user information stored by the social media platform that content from one user is to be shared with the other user. The similarity metric may be judged on a graduated scale such that only certain types of information from one user is shared with another in accordance with embodiments of this invention. Furthermore, the amount of information from one user shared with another may be based upon the similarity metric between the two users in accordance with some embodiments. For example, two users have a relatively high similarity metric. Thus, all comments by one user are shared with the other. Another user has a lower similarity metric with one of the users and only receives comments about a particular type of product or service made by the other user. In addition, one skilled in the art will note that steps 920-930 can be performed to make determinations about the similarity of any groups of user and is not restricted to being made when information is requested. One skilled in the art will recognize that similarity could also be applied to other objects, such as product, besides users to make recommendations.

Turning back to process 900 of FIG. 9, the piece of information provided by the user is added to a ranked list of the provided information based upon the similarity metric (935). This is to assure that comments made by similar users are more prominently displayed than information made by less similar users thereby attempting to provide the user more relevant information. The ranks may also be used to provide visual information about the level of similarity between the users in accordance with many of embodiments. In a number of embodiments, the rankings may be used to provide similarity adjusted ratings to a user. In some information, images and other relevant information about the subject may also be provided to the user.

The process then determines whether there is another piece of information and continues the comparisons of users until all of the pieces of information are processed (940). When all of the pieces of information are processed, the platform provides the list of ranked information to the user account for generation of interface that includes the information as ranked (945) and process 900 ends.

Although a specific process for providing information based upon the stored user information performed by a social media platform is described above with respect to FIG. 9, any of a variety of processes may be utilized in accordance with embodiments of the invention.

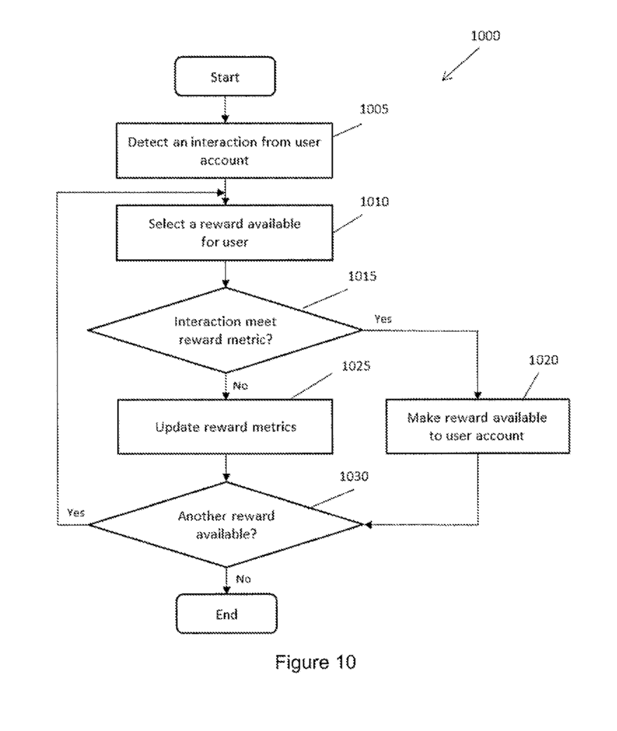

In accordance with some embodiments of the invention, the loyalty system also provides rewards in a game play manner. A game play manner means that the loyalty system provides challenges to the user and the user is provided rewards based on overcoming the challenges. The challenges are based upon interaction with the system. For example, the user may be rewarded for providing feedback about a comment, for recommending a vendor, product, and/or service to other users, for reaching a particular score in an entertainment game, or for any other type of interaction with the system. A process for providing awards based upon user interactions in accordance with embodiments of this invention is shown in FIG. 10.

Process 1000 begins when the platform detects an interaction from a user account (1005). The interaction may be any action that user can perform using the user account within the social media network. Examples of interactions include, but are not limited to, reporting of scores on entertainment games, posting of links, posting of comments, providing references to other users, and the like. The platform retrieves a list of rewards available to the user. The list also includes reward metrics for receiving each reward. A reward from the list is then selected (1010). The process then determines whether the metric for the reward is met by the detected interaction (1020). An example of a metric is obtaining a certain score playing an entertainment game. If the metric is obtained, the reward is provided to the user account for the user to redeem (1020).

If the metric is not met, the reward metrics may be updated to indicate the detected interaction (1025). For example, the metric is to make a certain number of comments on products by a vendor. The user makes a comment. However, the user has not made enough comments to obtain the reward. Thus, the metric is reduced by one to indicate the number of needed comments remaining to earn the reward. The process determines whether another comment is available and is repeating until all of the available rewards are processed (1030). After all of the rewards are processed, process 1000 ends.

Although a specific process for determining whether a reward should be provided to a user based upon an interaction as performed by a social media platform is described above with respect to FIG. 10, any of a variety of processes may be utilized in accordance with embodiments of the invention.

In accordance with some embodiments of the invention, the social networking platform may provide information about products and/or vendors based on recorded transactions to the users. The information may be obtained from POS systems and/or purchase patterns of users. The information may be used by users to determine the products and/or vendors that are popular that may be of interest to the user.

### Information Tagging

In accordance with some embodiments of the invention, the social media platform uses similarities between users and products to provide information to a user. In order to better provide the information, the social media platform may maintain a system for categorizing the information in a review and/or posting and provide tags that aid in the categorization of information in reviews and/or posts. The platform in accordance with some embodiments of this invention provides conventions for each type of category that are maintained by the use of tags. In accordance with many embodiments, the platform may provide a method for the user to select the appropriate tags for a post. In accordance with several embodiments, the platform may analyze the information in the review and/or post and add the appropriate tags. In accordance with many embodiments, the tags are conventional identifiers such as a ‘#’ hashtag followed by a word and/or an ‘@’ followed by a word. In accordance with a number of embodiments, a proprietary tag system may be used by platform. In accordance with numerous embodiments, tagging may be used to group multiple or duplicate reviews. This grouping may enable all the reviews and postings on the platform of duplicate items to be linked or grouped accordingly. In accordance with some embodiments, the items which exist on the platform may also be added by official accounts, or merchants. In some of these embodiments, the merchants, or official accounts create items through the steps which are covered through the item tagging process. However, the items added by merchants may have to be reviewed in order to ensure the official items added are befitting of a set standard, as adding of items by merchants would also make such items exist in the store for customer claims in some of these embodiments.

In accordance with some embodiments, the classifications for the tagging convention use the following convention, category, item identifier, item preference, and descriptors. The categories are different types of goods and/or services reviewed. Examples of categories include, but are not limited to, fashion, gadgets, and food. An item identifier is maintained for each item in a category. For example, in the food category, the item may be a restaurant or a specific dish served by particular restaurants. Furthermore, one skilled in the art will recognize that one or more item identifiers may be applied to a specific item. An example of two or more item identifiers applied to an item is a particular dish of food server at a particular restaurant may have an identifier that includes the name of the dish and the name of the restaurant. Furthermore, in accordance with each embodiment, each category may have a specific convention for providing an identifier. For example, foods and services may be identified by the tag ‘#food @<place>’, products may be identified by the tag ‘#model#brand#product’, and places may be identified by the tag ‘@<place>’ in accordance with a number of embodiments.

The item preference is a tag used to indicate how the user feels about the identified item. In accordance with some embodiments, the set of preference tags is different for different categories of items. In many embodiments, the preference tag may indicate the feeling of the users in simple phases such as, but not limited to, “Like”, “Dislike”, “Want”, “Need”, “Expensive”, “Bargain” and any other phase that may indicate the feelings of a user about the product.

In addition, the platform may maintain a specific set of descriptors associated with each category in accordance with some embodiments. For example, the food category may include, but not limited to, descriptors for taste, speed of preparation, and serving size; and the gadget category may include, but not limited to, descriptors for battery life, functionality, and design in accordance with a number of embodiments. The platform may also maintain a specific set of ratings for each descriptor that provide a concise description of the opinion about the descriptor expressed in the review and/or posting. For example, the platform may maintain the ratings including, but not limited to, good, bad, spicy, bland, hot and cold for the taste descriptor in the food category.

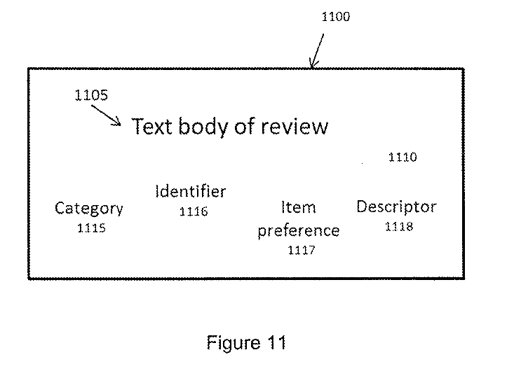

An example of a posting that includes tags that enforce a category convention maintained by a social media platform in accordance with an embodiment of the invention is shown in FIG. 11. Posting 1100 includes a body of text 1105 reviewing an item. A tag 1110 is inserted into the text of the posting 1100 at the end of the review. One skilled in the art will recognize that the tag may be placed anywhere in the text of posting 1100 and/or be interspersed throughout the text of the posting 1100 without departing from embodiments of the invention. Tag 1110 includes a tag identifying the category 1115, one or more tags identifying an item 1116, one or more tags indicating an item preference 1117, and one of more tags of descriptors 1118 associated with the category. In addition, the tag 1110 may include one or more tags for ratings of one or more of the included descriptors (not shown) in accordance with a number of embodiments of the invention. In some embodiments, a metric such as “xxx out of xxx similar users like this item” (Not Shown) may also be displayed.

### Processes for Providing Tags in Stored Information

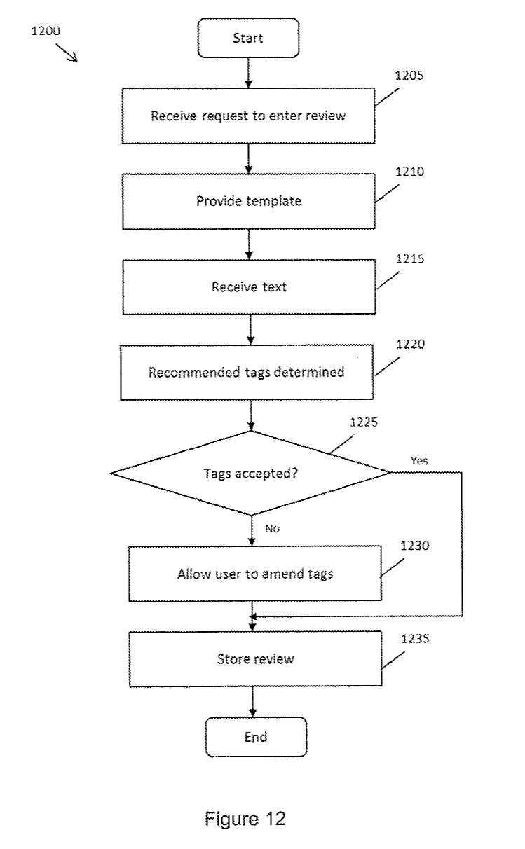

In accordance with embodiments of this invention, a social media platform enforces the system for categorizing information in a review and/or post by providing a process in which the maintained tags are inserted into the review and/or post. For purposes of this discussion, a post may be any type of data that may be related to a specific topic. The types of data may include, but are not limited to, video, image, audio, and text data. Specific topics may include, but are not limited to, places of interest, businesses, people, and products. A process (1200) for including tags in a review and/or post submitted to the social media network in accordance with an embodiment of the invention is shown in FIG. 12. One skilled in the art will recognize that in some embodiments, process 1200 may be performed by a process performed by a social network application being performed by the user device. In some other embodiments, the process 1200 may be performed by a social network provider system that is communicative connection with the user device.

Process 1200 begins when a request to receive a request to enter a review and/or post is received (1205). A template for providing the post and/or review is provided to the user in response to the request (1210). In accordance with some embodiments of the invention the template may provide dropdown boxes that allow the user to select the tags for categories, item identifiers, descriptors and/or ratings. In many embodiments, the dropdown boxes provided may be determined as information is selected in associated boxes. For example, the selection of food for the category tag may result in a set of restaurant names in an identifier dropdown box and a set of dropdown boxes for the descriptors of the food category being provided. In accordance with some embodiments, the template may provide an input to allow user preference tags for the item to be inserted. In a number of embodiments, the input may be a set of simple inputs such as, but not limited to, “Want it”, “Done it”, and “Like it”; or another similar set of tags. These tags identify the preferences/reviews inclination of a user in accordance with some of these embodiments.

The user then completes the template by providing text, images, and any other type of data permitted (1215). The text is received by process 1200 and a set of recommended tags are determined by analyzing the text (1220). In accordance with some embodiments, the tags are determined based upon the information provided in dropdown boxes. In a number of embodiments, the tags are provided using an autocomplete function during the entering of the text by the user. In many embodiments, the texted is parsed and analyzed to determine a recommended set of tags using an artificial intelligence algorithm such as, but not limited to, a neural network algorithm.

The determined tags are then displayed to the user. In accordance with some embodiments, only the recommended tags are displayed. In a number of embodiments, the entire text of the review and/or post is displayed including the recommended tags. The user may then accept the recommended tags (1225). In accordance with some embodiments, the acceptance may be made by accepting the entirety of the review and/or post.

If the tags are not accepted, the process 1200 may allow the user to amend the tags to desired tags (1230). In accordance with some embodiments, the process may allow the user to input new tags for the identifier, descriptors, and/or ratings. In accordance with many embodiments, the user is limited to only selecting from pre-existing tags in making any amendments to the tags. After the amendments are accepted and/or any amendments to the tags are made. The tags are inserted into the review and the review is stored by the social media platform (1235) and the process 1200 ends.

Although a specific process for inserting tags into a posting as performed by a social media platform is described above with respect to FIG. 12, any of a variety of processes to insert tag into postings may be utilized in accordance with embodiments of the invention.

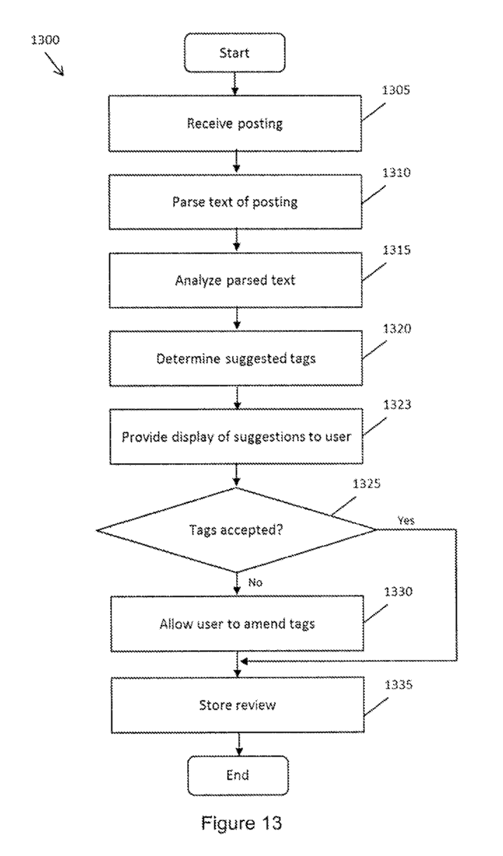

In accordance with some embodiments of the invention, the social media platform may allow a user to place the tags for categorization system maintained by the system to be placed into material imported from other sources by a user. The sources may be articles downloaded from other sources, user's blogs, and/or any other source for obtaining information to provide to the system. A process (1300) for providing tags for imported material in accordance with an embodiment of this invention is shown in FIG. 13. One skilled in the art will recognize that in some embodiments, process 1300 may be performed by a process performed by a social network application being performed by the user device. In some other embodiments, the process 1300 may be performed by a social network provider system that is communicative connection with the user the device.

The process 1300 begins by receiving content from a user to post to the user account of the user (1305). The process then uses a conventional process to parse the text to the posting (1310). The parsed text is then analyzed using a natural language processing technique and/or an artificial intelligence algorithm such as, but not limited to, a neural network algorithm (1315). Based on the analysis, set of suggested tags are determined (1320) that represent the appropriate category(ies), item identifier(s), descriptor(s), and ratings to describe the material. The determined tags are then displayed to the user (1323). In accordance with some embodiments, only the recommended tags are displayed. In a number of embodiments, the entire text of the posting is displayed including the recommended tags. The user may then accept the recommended tags (1325). In accordance with some embodiments, the acceptance may be made by accepting the entirety of the posting.

If the tags are not accepted, the process 1300 may allow the user to amend the tags to desired tags (1330). In accordance with some embodiments, the process may allow the user to input new tags for the identifier, descriptors, and/or ratings. In accordance with many embodiments, the user is limited to only selecting from pre-existing tags in making any amendments to the tags. After the tags are accepted and/or any amendments to the tags are made. The tags are inserted into the posting and the posting is stored by the social media platform (1335) and the process 1300 ends.

Although a specific process for inserting tags into a posting as performed by a social media platform is described above with respect to FIG. 13, any of a variety of processes to insert tag into postings may be utilized in accordance with embodiments of the invention.

### Processes for Providing Information to a User

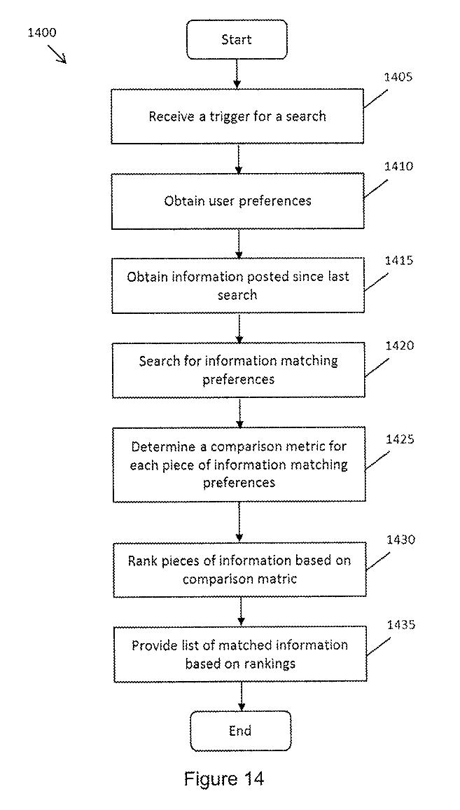

In accordance with embodiments of the invention, the information tagged in accordance with the categorizing enforced by the social media platform may be searched to provide information to a user based on the user preferences of the user. The information may then be ranked based upon similarities the user preferences. A process (1400) for providing information to user in accordance with an embodiment of the invention is shown in FIG. 14.

Process 1400 begins when a trigger is received for a search (1405). In accordance with some embodiments, a log-in to the social media platform may be a trigger for a search. In many embodiments, a time event may be trigger for a search. In accordance with a number of embodiments, a user may request a search. One skilled in the art will recognize that any number of events and/or interactions between a user and the social media platform may be triggers for a search without departing from embodiments of this invention. In accordance with a number of embodiments, a trigger may be system-generated for the user, or initiated by the user himself. In addition to search, a user is able to “browse” items which belong to particular interest groups, such as #bestComfortFood, which are stored in the platform to provide a topic, or theme to group the reviews of items. The search may include other data which exists on the platform in some embodiments. For example, real-time purchasing information which is available with the POS device or integrated with an actual POS system enables searches which may make use of real-time sales information, such as “where is some item available, which is still in stock”, as real-time information would help improve on the accuracy of such searches in a number of embodiments.

In response to the trigger for a search, the user preferences are retrieved (1410). In accordance with some embodiments, the user preferences are stored by the social media platform as a part of a user account in a user database. The information posted to the social media platform since the last search performed previous to the current search are determined (1415) and searched (1420), The search performed in a predictive model such as, but not limited to, a neural network algorithm that is maintained and retrained as new information is added. In accordance with a number of embodiments, the predictive model uses search criteria such as, but not limited to, trending information, input search criteria, and the user preferences to search the posts for information that may be of interest to the user. The search may be aided by the searching of tags in the postings in accordance with some embodiments of the invention. In accordance with some embodiments, the users may browse for updates using tags as a criteria for the search. For example, the user may use the tag “#BestComfortFood” to find foods that have been given such a tag and as such may interest the user in some embodiments.

The process then determines a comparison metric for each posting determined to match the search criteria and the user preferences (1425). The comparison metric is similar to the comparison metric described above with reference to the process 900 shown in FIG. 9. The similarity metrics of the postings are then used to provide a ranked list of the postings to provide to the user (1435) and the process 1400 ends. In some embodiments, a metric that describes similarity of users that like the posting may be used. For example, it is possible that each posting is ranked by a metric showing the number of similar users that that the posting (such as “243 out 2,142 similar users like this”). The social media platform may then use the list to provide information to the user in accordance with the event that triggered the search.

Although a specific process for searching posting as performed by a social media platform is described above with respect to FIG. 14, any of a variety of processes to insert tag into postings may be utilized in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1-69. (canceled)

70. A social media platform that provides a loyalty system comprising:
a group of processors that includes at least one processor;
memory accessible by the group of processors; and
instructions stored in the memory that configure the group of processors to:
maintain a cumulative purchase record of total amount of purchases by a user from a set of participating vendors wherein the cumulative purchase record stores a cumulative metric that indicates a total amount of purchases by the user from the set of participating vendors,
maintain a specific vendor purchase record of total amount of purchases by the user from a specific subset of vendors in the set of participating vendors wherein the specific vendor purchase record stores a specific vendor metric that indicates a total amount of purchases from the specific subset of vendors,
receive an indication of a purchase from one of the set of participating vendors wherein the indication includes an amount of the purchase, an identification of the user and an identity of the one of the set of participating vendors of the purchase,
update the cumulative purchase record of total purchases of the user wherein the cumulative metric is changed based upon the amount of the purchase,
determine whether a specific vendor record exists for a subset of the set of participating vendors that includes the one of the set of participating vendors of the purchase,
update the specific vendor record wherein the specific vendor metric is changed based upon the amount of the purchase,
determine whether a mobile device is associated with the user from stored user account information and information received in the indication of the purchase in response to receiving the indication of a purchase,
provide a feedback template to the mobile device associated with the user in response to a determination that the mobile device is associated with the user,
receive a populated template from the mobile device that includes feedback data input by the user,
store the feedback data, and
link the feedback data to at least one of a group selected from the user, a product, a service, a vendor and a vendor location.

71. The system of claim 70 wherein the subset of participating vendors is one of a single specified vendor and a plurality of affiliated vendors wherein the number of plurality of affiliated vendors is less than the total number of the plurality of participating vendors.

72. The system of claim 70 wherein the instructions configuring the group of processors to update the cumulative purchase record include instructions configuring the group of processors to:
retrieve a set of rules for cumulative purchases applicable to the user, and
apply the set of rules for cumulative purchases to the purchase to determine the change to the cumulative metric.

73. The system of claim 70 wherein the instructions configuring the group of processors to update the specific vendor record include instructions configuring the group of processors to:
retrieve a set of rules for specific vendor purchases applicable to the user, and
apply the set of rules for specific vendor purchases to the purchase to determine the change to the specific vendor metric.

74. The system of claim 70 wherein the instructions include instructions for configuring the group of processors to:
provide a comment code that corresponds to the purchase to a point of sale device for printing on a receipt in response to receiving the indication of a purchase;
receive the comment code from a user device;
provide feedback template to the user account of the user in response to receiving the comment code;
receive a populated template from the user that includes feedback data input by the user;
store the feedback data; and
link the feedback data to at least one of a group selected from the user, a product, a service, a vendor and a vendor location.

75. The system of claim 70 wherein the instructions includes instructions for configuring the group of processor to:
receive an indication that a user device associated with the user is detected at a vendor location;
determine whether the user is eligible for a reward for being at the vendor location; and
update the user account of the user with an indication of the reward in response to a determination that the user is eligible for the reward.

76. The system of claim 70 wherein the instructions includes instructions for configuring the group of processors to:
receive an indication that a user device associated with the user is detected at a vendor location;
determine a number of devices associated with users affiliated with the user that are detected in the vendor location;
determine whether the number of devices in the vendor location is greater than a threshold;
determine whether the user and users affiliated with the user at the vendor location are entitled to a reward based upon the comparison of the number of devices to the threshold; and
update the user account of the user and user account of each user affiliated with the user in the vendor location with an indication of the reward in response to a determination that the user and the users affiliated with the user in the vendor location are eligible for the reward.

77. The system of claim 70 wherein the instructions include instructions for configuring the group of processors to:
receive a request from a user to redeem a selected metric from one of the cumulative purchase metric in the cumulative purchase record and the specific vendor metric stored in the specific vendor purchase record for a reward;
determine rewards that may be obtained using the selected metric;
provide a list including the determined rewards to the user;
receive a selection of a particular reward from the user; and
provide a voucher for the reward to the user account of the user.

78. The system of claim 77 wherein the instructions include instructions for configuring the group of processors to:
update the selected metric in the selected one of the cumulative purchase record and the specific vendor purchase record to indicate the redemption of the reward.

79. The system of claim 77 wherein the instructions include instructions for configuring the group of processors to:
receive a request for use of a reward by user from a vendor system;
verify the reward in the user account of the user;
update the user account of the user to indicate the reward is redeemed; and
transmit an indication of the reward to the vendor system.

80. The system of claim 70 wherein the instructions include instructions for configuring the group of processors to:
receive a request from a user to provide information about a particular item to the user account of the user;
retrieve information related to the item from the memory;
determine a source user of each piece of information related to the item;
compare stored user information about the user to stored user information about the source user for each piece of information to generate a comparison metric for the source user;
rank each piece of information about an item based on the comparison metrics for each of the source users; and
generate a display of the information based upon the ranked information about the item.

81. The system of claim 70 wherein the instructions include instructions configuring the group of processor to:
select a group of other users;
retrieve user information for the user and each user in the group of other users;
compare the user information of the user to the user information for each user in the group of other users to generate a comparison metric;
determine whether the comparison metric for each user in the group of other users is greater than a threshold; and
add a link between the user and each user in the group of other users that has a comparison metric determined to be greater than the threshold.

82. The system of claim 81 wherein the instructions include instructions for configuring the group of processors to provide information to the user that is added to by each other user that is linked to the user based on the comparison metric.

83. The system of claim 70 wherein the instructions include instructions configuring the group of processor to:
detect an interaction from the user;
determine whether the interaction meets a reward metric for a reward available to the user; and
add the reward to available rewards for redemption in the user account of the user in response to a determination that the interaction meets the reward metric.

84. The system of claim 83 wherein the instructions include instructions configuring the processor to:
update the reward metrics based upon the interaction in response to a determination that interaction does not meet the reward metric.

85. A method for providing a loyalty system using a social media platform that is provided by a group of processing systems including at least one processing system, the method including:
maintaining a cumulative purchase record of total amount of purchases by a user from a set of participating vendors wherein the cumulative purchase record stores a cumulative metric that indicates a total amount of purchases by the user from the one of the set of participating vendors;
maintaining a specific vendor purchase record of total amount of purchases by the user from a specific subset of vendors of the set of participating vendors wherein the specific vendor purchase record stores a specific vendor metric that indicates a total amount of purchases from the specific subset of vendors;
receiving an indication of a purchase from one of the set of participating vendors wherein the indication includes an amount of the purchase, an identifier of the user and an identifier for the one of the set of participating vendors of the purchase;
updating the cumulative purchase record of total purchases of the user wherein the cumulative metric is changed is based upon the amount of the purchase;
determining whether a specific vendor record exists for a subset of the set of participating vendors that includes the one of the set of participating vendors of the purchase;
updating the specific vendor record wherein the specific vendor metric is changed based upon the amount of the purchase;
determining whether a mobile device is associated with the user from stored user account information and information received in the indication of the purchase in response to receiving the indication of a purchase;
providing a feedback template to the mobile device associated with the user in response to a determination that the mobile device is associated with the user;
receiving a populated template from the mobile device that includes feedback data input by the user;
storing the feedback data; and
linking the feedback data to at least one of a group selected from the user, a product, a service, a vendor and a vendor location.

86. The method of claim 85 wherein the subset of the set of participating vendors includes one of a single specified vendor and a plurality of affiliated vendors wherein the number of plurality of affiliated vendors is less than the total number of the plurality of participating vendors.

87. The method of claim 85 wherein the updating the cumulative purchase record includes:
retrieving a set of rules for cumulative purchases applicable to the user; and
applying the set of rules for cumulative purchases to the purchase to determine the change to the cumulative metric.

88. The method of claim 85 the updating of the specific vendor record includes:
retrieving a set of rules for specific vendor purchases applicable to the user; and
applying the set of rules for specific vendor purchases to the purchase to determine the change to the specific vendor metric.

89. The method of claim 85 further comprising:
providing a comment code that corresponds to the purchase to a point of sale device for printing on a receipt in response to receiving the indication of a purchase;
receiving the comment code from a user;
providing feedback template to the user account of the user in response to receiving the comment code;
receiving a populated template from the user that includes feedback data input by the user;
storing the feedback data; and
linking the feedback data to at least one of a group selected from the user, a product, a service, a vendor and a vendor location.

90. The method of claim 85 further comprising:
receiving an indication that a user device associated with the user is detected at a vendor location;
determining whether the user is eligible for a reward for being at the vendor location; and
updating the user account of the user with an indication of the reward in response to a determination that the user is eligible for the reward.

91. The method of claim 85 further comprising:
receiving an indication that a user device associated with the user is detected at a vendor location;
determining a number of devices associated with users affiliated with the user that are detected in the vendor location;
determining whether the number of devices in the vendor location is greater than a threshold;
determining whether the user and users affiliated with the user at the vendor location are entitled to a reward based upon the comparison of the number of devices to the threshold; and
updating the user account of the user and user account of each user affiliated with the user in the vendor location with an indication of the reward in response to a determination that the user and the users affiliated with the user in the vendor location are eligible for the reward.

92. The method of claim 85 further comprising:
receiving a request from a user to redeem a selected metric from one of the cumulative purchase metric stored in the cumulative purchase record and the specific vendor metric stored in the specific vendor purchase record for a reward;
determining rewards that may be obtained using the selected metric;
providing a list including the determined rewards to the user;
receiving a selection of a particular reward from the user; and
providing a voucher for the reward to the user account of the user.

93. The method of claim 92 further comprising:
updating the selected metric in the selected one of the cumulative purchase record and the specific vendor purchase record to indicate the redemption of the reward.

94. The method of claim 92 further comprising:
receiving a request for use of a reward by user from a vendor system;
verifying the reward in the user account of the user;
updating the user account of the user to indicate the reward is redeemed; and
transmitting an indication of the reward to the vendor system.

95. The method of claim 85 further comprising:
receiving a request from a user to provide information about a particular item to the user account of the user;
retrieving information related to the item from the memory;
determining a source user of each piece of information related to the item;
comparing stored user information about the user to stored user information about the source user for each piece of information to generate a comparison metric for the source user;
ranking each piece of information about an item based on the comparison metrics for each of the source users; and
generating a display of the information based upon the ranked information about the item.

96. The method of claim 85 further comprising:
selecting a group of other users;
retrieving user information for the user and each user in the group of other users;
comparing the user information of the user to the user information for each user in the group of other users to generate a comparison metric;
determining whether the comparison metric for each user in the group of other users is greater than a threshold; and
adding a link between the user and each user in the group of other users that has a comparison metric determined to be greater than the threshold.

97. The method of claim 96 further comprising providing information to the user that is added to by each other user that is linked to the user based on the comparison metric.

98. The method of claim 85 further comprising:
detecting an interaction from the user;
determining whether the interaction meets a reward metric for a reward available to the user; and
adding the reward to available rewards for redemption in the user account of the user in response to a determination that the interaction meets the reward metric.

99. The method of claim 98 further comprising:
updating the reward metrics based upon the interaction in response to a determination that interaction does not meet the reward metric.

100. A social media platform that provides a loyalty system wherein the social media platform is provided with at least one processor, memory accessible by the at least one processor, and instructions in the memory that cause the at least one processor to configure circuitry in the system to:
maintain a cumulative purchase record of total amount of purchases by a user from a set of participating vendors wherein the cumulative purchase record stores a cumulative metric that indicates a total amount of currency spent on purchases by the user from the set of participating vendors;
maintain a specific vendor purchase record of total amount of purchases by the user from a specific subset of vendors in the set of participating vendors wherein the specific vendor purchase record stores a specific vendor metric that indicates a total amount of purchases from the specific subset of vendors;
receive an indication of a purchase from one of the set of participating vendors wherein the indication includes an identifier of the user, an amount of the purchase and an identifier of the one of the set of participating vendors of the purchase;
update the cumulative purchase record of total purchases of the user wherein the cumulative metric is changed is based upon the amount of the purchase;
determine whether a specific vendor record exists for a subset of the set of vendors that includes the one of the set of participating vendors of the purchase;
update the specific vendor record wherein the specific vendor metric is changed based upon the amount of the purchase;
determine whether a mobile device is associated with the user from stored user account information in response to receiving the indication of a purchase;
provide a feedback template to the mobile device associated with the user in response to a determination that the mobile device is associated with the user;
receive a populated template from the mobile device that includes feedback data input by the user;
store the feedback data; and
link the feedback data to at least one of a group selected from the user, a product, a service, a vendor and a vendor location.

101. The system of claim 100 wherein the subset of the set of participating vendors includes one of a single specified vendor and a plurality of affiliated vendors wherein the number of plurality of affiliated vendors is less than the total number of the plurality of participating vendors.

102. The system of claim 100 wherein the at least one processor further configures circuitry in the system to:
retrieve a set of rules for cumulative purchases applicable to the user; and
apply the set of rules for cumulative purchases to the purchase to determine the change to the cumulative metric.

103. The system of claim 100 wherein the at least one processor further configures circuitry in the system to:
retrieve a set of rules for specific vendor purchases applicable to the user; and
apply the set of rules for specific vendor purchases to the purchase to determine the change to the specific vendor metric.

104. The system of claim 100 wherein the at least one processor further configures circuitry in the system to:
provide a comment code that corresponds to the purchase to a point of sale device for printing on a receipt in response to receiving the indication of a purchase;
receive the comment code from a user;
provide feedback template to the user account of the user in response to receiving the comment code;
receive a populated template from the user that includes feedback data input by the user;
store the feedback data; and
link the feedback data to at least one of a group selected from the user, a product, a service, a vendor and a vendor location.

105. The system of claim 100 wherein the at least one processor further configures circuitry in the system to:
receive an indication that a user device associated with the user is detected at a vendor location;
determine whether the user is eligible for a reward for being at the vendor location; and
update the user account of the user with an indication of the reward in response to a determination that the user is eligible for the reward.

106. The system of claim 100 wherein the at least one processor further configures circuitry in the system to:
receive an indication that a user device associated with the user is detected at a vendor location;
determine a number of devices associated with users affiliated with the user that are detected in the vendor location;
determine whether the number of devices in the vendor location is greater than a threshold;
determine whether the user and users affiliated with the user at the vendor location are entitled to a reward based upon comparison of the number of devices to the threshold; and
update the user account of the user and user account of each user affiliated with the user in the vendor location with an indication of the reward in response to a determination that the user and the users affiliated with the user in the vendor location are eligible for the reward.

107. The system of claim 100 wherein the at least one processor further configures circuitry in the system to:
receive a request from a user to redeem a metrics from one of the cumulative purchase metric stored in the cumulative purchase record and the specific vendor metric stored in the specific vendor purchase record for a reward;
determine rewards that may be obtained using the selected metric;
provide a list including the determined rewards to the user;
receive a selection of a particular reward from the user; and
provide a voucher for the reward to the user account of the user.

108. The system of claim 107 wherein the at least one processor further configures circuitry in the system to:
update the selected metric in the selected one of the cumulative purchase record and the specific vendor purchase record to indicate the redemption of the reward.

109. The system of claim 107 wherein the at least one processor further configures circuitry in the system to:
receive a request for use of a reward by user from a vendor system;
verify the reward in the user account of the user;
update the user account of the user to indicate the reward is redeemed; and
transmit an indication of the reward to the vendor system.

110. The system of claim 100 wherein the at least one processor further configures circuitry in the system to:
receive a request from a user to provide information about a particular item to the user account of the user;
retrieve information related to the item from the memory;
determine a source user of each piece of information related to the item;
compare stored user information about the user to stored user information about the source user for each piece of information to generate a comparison metric for the source user;
rank each piece of information about an item based on the comparison metrics for each of the source users; and
generate a display of the information based upon the ranked information about the item.

111. The system of claim 100 wherein the at least one processor further configures circuitry in the system to:
select a group of other users;
retrieve user information for the user and each user in the group of other users;
compare the user information of the user to the user information for each user in the group of other users to generate a comparison metric;
determine whether the comparison metric for each user in the group of other users is greater than a threshold; and
add a link between the user and each user in the group of other users that has a comparison metric determined to be greater than the threshold.

112. The system of claim 111 wherein the wherein the at least one processor further configures circuitry in the system to provide information to the user that is added to by each other user that is linked to the user based on the comparison metric.

113. The system of claim 100 wherein the at least one processor further configures circuitry in the system to:
detect an interaction from the user;
determine whether the interaction meets a reward metric for a reward available to the user; and
add the reward to available rewards for redemption in the user account of the user in response to a determination that the interaction meets the reward metric.

114. The system of claim 113 wherein the at least one processor further configures circuitry in the system to:
update the reward metrics based upon the interaction in response to a determination that interaction does not meet the reward metric.

115. A system for providing a social media platform comprising:
a group of processors including at least one processor;
memory accessible by the group of processors; and
instructions stored in the memory that configure the at least one processor to:
maintain a set of tags that are used to categorize information in postings to a social media platform wherein the set of tags provide a convention for identifying properties of each of a plurality of types of items;
receive a posting to the social media platform;
analyze the data in the posting;
determine one or more tags from the set of tags maintained to add to the posting to categorize the information in the posting;
add the one or more tags to the posting;
store the posting for use in the social media platform;
receive a trigger to search for information about a particular item in postings maintained by the social media platform from a user;
retrieve user preferences for the user from user information maintained by the social media platform;
retrieve postings to the social media platform related to the particular item from memory by:
searching each posting for tags associated with the particular item requested by the user, and
retrieving each posting that includes the tags associated with the particular item;
compare the user preferences of the user to information in each of the retrieved postings to generate a comparison metric for each posting;
rank each posting about the particular item based on the comparison metrics for each posting; and
provide a ranked list of the postings for use in satisfying an event that invoked the trigger.

116. The system of claim 115 wherein the set of tags categorize the information by providing a type of item category, an item identifier, and one or more descriptors of the item based on the type of item category.

117. The system of claim 115 further comprising:
instructions stored in the memory that configure the one or more processors to:
provide a display of the one or more tags determined for the posting to a user; and
receive an acceptance of the one or more tags from the user prior to adding the one or more tags to the posting.

118. The system of claim 115 further comprising:
instructions stored in the memory that configure the one or more processors to:
receive a request to enter a review from a user,
provide a template to the user,
receive text entered into the template by the user,
determine one or more tags from the set of tags that categorize the information in the text,
provide a display of the one or more tags to the user,
receive an acceptance of the one or more tags from the user,
insert the one or more tags into the template including the review, and
store the review for use by the social media platform.

119. A method for providing a social media platform performed by a group of processing systems including at least one processing system that provide the social media platform, the method including:
maintaining a set of tags that are used to categorize information in posting to the social media platform wherein the set of tags provide a convention for identifying properties of each of a plurality of types of items;
receiving a posting to the social media platform;
analyzing the data in the posting;
determining one or more tags from the set of tags maintained to add to the posting to categorize the information in the posting;
adding the one or more tags to the posting;
storing the posting for use in the social media platform;
receiving a trigger to search for information about a particular item in postings maintained by the social media platform from a user;
retrieving user preferences for the user from user information maintained by the social media platform;
retrieving postings to the social media platform related to the particular item from memory by:
searching each posting for tags associated with the particular item requested by the user, and
retrieving each posting that includes the tags associated with the particular item;
comparing the user preferences of the user to information in each of the retrieved postings to generate a comparison metric for each posting;
ranking each posting about the particular item based on the comparison metrics for each posting; and
providing a ranked list of the postings for use in satisfying an event that invoked the trigger.

120. The method of claim 119 wherein the set of tags categorize the information by providing a type of item category, an item identifier, and one or more descriptors of the item based on the type of item category.

121. The method of claim 119 further comprising:
providing a display of the one or more tags determined for the posting to a user; and
receiving an acceptance of the one or more tags from the user prior to adding the one or more tags to the posting.

122. The method of claim 119 further comprising:
receiving a request to enter a review from a user;
providing a template to the user;
receiving text entered into the template by the user;
determining one or more tags from the set of tags that categorize the information in the text;
providing a display of the one or more tags to the user;
receiving an acceptance of the one or more tags from the user;
inserting the one or more tags into the template including the review; and
storing the review for use by the social media platform.

123. A system for providing a social media platform wherein the system includes at least one processor and memory accessible by the at least one processor and instructions in the memory that cause the at least one processor to configure circuitry in the system to:
maintain a set of tags that are used to categorize information in postings to a social media platform wherein the set of tags provide a convention for identifying properties of each of a plurality of types of items;
receive a posting to the social media platform;
analyze the data in the posting;
determine one or more tags from the set of tags maintained to add to the posting to categorize the information in the posting;
add the one or more tags to the posting;
store the posting for use in the social media platform;
receive a trigger to search for information about a particular item in postings maintained by the social media platform from a user;
retrieve user preferences for the user from user information maintained by the social media platform;
retrieve postings to the social media platform related to the particular item from memory by:
searching each posting for tags associated with the particular item requested by the user, and
retrieving each posting that includes the tags associated with the particular item;
compare the user preferences of the user to information in each of the retrieved postings to generate a comparison metric for each posting;
rank each posting about the particular item based on the comparison metrics for each posting; and
provide a ranked list of the postings for use in satisfying an event that invoked the trigger.

124. The system of claim 123 wherein the set of tags categorize the information by providing a type of item category, an item identifier, and one or more descriptors of the item based on the type of item category.

125. The system of claim 123 wherein the at least one processor further configures circuitry in the system to:
provide a display of the one or more tags determined for the posting to a user; and
receive an acceptance of the one or more tags from the user prior to adding the one or more tags to the posting.

126. The system of claim 123 wherein the at least one processor further configures circuitry in the system to:
receive a request to enter a review from a user;
provide a template to the user;
receive text entered into the template by the user;
determine one or more tags from the set of tags that categorize the information in the text;
provide a display of the one or more tags to the user;
receive an acceptance of the one or more tags from the user;
insert the one or more tags into the template including the review; and
store the review for use by the social media platform.
